(19) United States
(12) Patent Application Publication
(10) Pub. No.: US 2007/0235389 A1
(43) Pub. Date: Oct. 11, 2007

(54) Metal-coated superficially porous supports as a medium for HPLC of phosphorus-containing materials

(76) Inventors: Barry E. Boyes, Wilmington, DE (US); James D. Martosella, Downingtown, PA (US); Susanne C. Moyer, Newark, DE (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/401,602

(22) Filed: Apr. 10, 2006

(51) Int. Cl. G01N 1/18; B01D 15/04

(52) U.S. Cl. 210/649; 436/177; 435/7.1; 210/638; 210/656; 436/178

(57) ABSTRACT

Methods for the separation of biological materials from a sample mixture using a superficially porous particle coated (or clad) with a metal are provided herein. Methods using the support as a chromatographic column are also provided.

### REFERENCE TO RELATED APPLICATIONS

This application is a nonprovisional application and is related to, and claims priority to, copending United States nonprovisional application Serial Nos. ______, filed evendate herewith, and entitled “Metal-coated Sorbents as Separation Medium for HPLC of Phosphorus-containing Materials,” and “Titanium-coated Sorbents as Separation Medium for HPLC of Phosphorus-containing Materials,” the disclosures of which are incorporated herein by reference in their entirety.

### BACKGROUND

Interest in proteomics analysis has increased dramatically over the past several years. The biological systems used in proteomics analysis are often very complex, containing mixtures of different chemical compounds present at different concentrations, such as proteins. Of particular interest are phosphorylated proteins, which play an important role in cell signaling. Therefore, effective isolation, detection and separation of such compounds are necessary. Multi-dimensional separation techniques such as liquid chromatography, including high-performance liquid chromatography (HPLC), are typically used for such separations.

Immobilized metal affinity chromatography (IMAC) has been used for the selective binding of peptides and proteins, as explained in Porath et al., A New Approach to Protein Fractionation, Nature, 258: 598-599 (1975). This technique is based on interaction between an electron-donating group on a protein surface, and a metal cation with one or more accessible coordination sites. The metal ion, in turn, is attached to a metal-chelating groups attached to a solid matrix or support.

The ligands used in IMAC are usually tri-, tetra-, or pentadentate, providing metal chelation to the ligand bound on the solid support, while maintaining additional free sites for coordination of the metal with the analyte. For example, a widely used form of IMAC used Ni(II)-chelated ligand for the selection and purification of His-tagged proteins. Here, Ni²⁺, a borderline acid coordinates with imidazole, a borderline base on the histidine side chain, allowing for purification of recombinant proteins with a His-6 tag.

Selective coordination of a particular metal with a specified functional group is dependent on pH. In a typical IMAC experiment, metal ions are loaded onto a chelating solid support, followed by binding of the target analyte (such as a phosphopeptide) to the metal ion. Changes in pH affect the electron donor-acceptor properties of the analyte and metal. For example, with phosphorylated compounds, optimal binding occurs at very low pH (typically<3.5), where there is no interference from other charged groups such as the carboxylic acid moieties of aspartic and glutamic acid residues. However, as the pH is lowered, the ligand that coordinates the metal becomes protonated. Thus, the negative charge used to non-covalently coordinate the ligand with the positive charge on the metal is eliminated. This causes a loss of the metal bound to the solid support and a consequent loss of the solid support's binding ability. If, on the other hand, the pH is increased to avoid protonation and preserve phosphate-binding ability, carboxylic acid moieties also bind to the metal, reducing the selectivity of the metal-coordinated solid support for separation of phosphorus-containing compounds. Problems with metal ion leakage from the chelating solid support and subsequent contamination of the separated biological product have also been observed in IMAC.

### SUMMARY

The present disclosure relates to methods for separating biological materials including proteins, polypeptides, polynucleotides, phosphopeptides, their chemical or synthetic equivalents, or mixtures thereof. In one aspect, the disclosure provides a method for separating target biological materials from a sample mixture, using a metal-coated superficially porous support.

In another aspect, the disclosure provides a method for separating target biological materials from a sample mixture containing one or more biological components. The sample mixture is contacted with the metal-coated support and the target material is captured on the support, or eluted from the support. The selectivity of the support for a particular biological material is achieved by varying the pH during separation. The selectivity of the support for a particular biological material can also be controlled by varying the metal coating on the superficially porous support.

### DETAILED DESCRIPTION

Various embodiments of the methods described herein will be described in detail. Reference to various embodiments does not limit the scope of the claims attached hereto. Additionally, any examples set forth in this specification are not intended to be limiting and merely set forth some of the many possible embodiments of the claims.

Unless defined otherwise, all technical and scientific terms used herein have the same meaning as commonly understood by one of ordinary skill in the art. Although any methods and materials similar or equivalent to those described herein can also be used in the practice or testing of the present disclosure, the preferred methods and materials are now described. Methods recited herein may be carried out in any order that is logically possible, in addition to a particular order disclosed.

In this specification and the appended claims, the singular forms “a,” “an,” and “the” include plural reference, unless the context clearly dictates otherwise. Unless defined otherwise, all technical and scientific terms used herein have the same meaning as commonly understood too one of ordinary skill in the art.

Superficially Porous Particles

In embodiments the present description relates to a superficially porous support for selective separation of biological materials, including phosphorus-containing materials. The support can also include a superficially porous particle coated (or clad) with a metal, the metal being chosen for its binding affinity for a specific biological material. The present description also relates to methods for the selective separation of biological materials using a superficially porous metal support or superficially porous particle coated (or clad) with a metal as a stationary phase for chromatography.

A support comprising a macroparticulate core coated with a layer of microparticles to form a superficially porous support is described herein. In one embodiment, the support can be used as the stationary phase in liquid chromatography, for selective separation of biological material from a sample. In another embodiment, the support is used in a spin column, as a membrane coating, or a free powder. In another embodiment, the support is used in methods to selectively remove biological material from a sample. In a further aspect, the support can be used for separations of macromolecules such as proteins. The support can also be used for separation of highly hydrophobic compounds that are strongly retained on the stationary phase in liquid chromatography, and also for the selective removal or capture of biological compounds. In an aspect, the support demonstrates fewer unwanted interactions with the biological materials being separated and, therefore maintains high sample recovery.

In an embodiment, the superficially porous support consists of a layer of spherical porous microparticles adhered onto a macroparticulate non-porous core material. A method for preparing such a superficially porous support is described in Bergna (U.S. Pat. No. 4,477,492), and in Kirkland, J. Chromatography A 965: 25-34 (2000), which are incorporated herein by reference.

In one aspect, this superficially porous support shows high column efficiencies and superior kinetics properties during liquid chromatography, when compared to supports using totally porous particles of the same size. In another aspect, the superficially porous microparticles of the support have a lower surface area than totally porous particles of comparable size. This allows for lower solute retention and less column variability with changes in pH. The superficially porous support is more reproducible than a totally porous support because of the mass transfer kinetics of the thin microparticulate coating. Systems comprising the superficially porous support can be used repeatedly.

In one aspect, the superficially porous support comprises a macroparticulate non-porous inner core material coated with a microparticulate outer layer. The composition of the core macroparticle is not critical except that it should be stable and suitable to be coated with a metal or metal oxide microparticulate. The cores can be for example, glasses, sand, ceramics, metals or oxides. In addition to truly impervious cores such as these, other types such as aluminum silicate molecular-sieve crystals or small-pore porous oxide microspheres, such as those described in Iler (U.S. Pat. No. 3,855,172), for example. The size of the cores is not critical and may range from about 2 to about 50 μm.

In an embodiment, the superficially porous support comprises a macroparticulate non-porous core material coated with a microparticulate outer layer. The outer microparticulate coating consists of a thin layer of inorganic microparticles. These microparticles can be any desired inorganic substance composition-wise which can bind a specific biological containing compound. Additionally, the microparticles of the outer coating can be reduced to a colloidal state and have chemical properties that allow adhesion to the macroparticulate core. The size of these microparticles is not critical, and may range from about 2 to about 30 nm. In a preferred embodiment, the superficially porous support comprising the macroparticle core and microparticle outer coating will range in size from about 3 to about 50 μm, with an average particle diameter of about 5 μm.

In an embodiment, the superficially porous support comprises an outer layer of metal microparticles. In one aspect, the superficially porous support is stabilized against degradation by the metal coating so that the support can be used over a wide range of pH values. In another aspect, the metal microparticulate layered superficially porous support serves as a replacement technology for IMAC, where a metal is chelated with an acidic ligand that is bound to a solid chromatographic support. Although not limiting to the present disclosure, a metal-coated superficially porous support, as described in this disclosure, will be stable over a wide pH range because the ligand is not protonated when the pH is altered and therefore, the metal microparticulate layer retains its ability to bind the analyte of interest.

In an embodiment, the metal microparticulate layer on the superficially porous particle can be varied based on the affinity of a given metal for a desired biological material to be separated from a sample. The sample is typically any mixture of biological material including, but not limited to, proteins, nucleotides, and their modified and/or processed forms. The sample can be derived from biological fluid (such as blood, plasma, serum, urine, tears, etc., for example). The sample can also be obtained from a variety of sources including, without limitation, cell samples, organisms, subcellular fractions, etc. In one aspect, the biological material is a phosphorus-containing compound, including, without limitation, phosphoric esters, phosphates, phosphonates, phosphoric anhydrides, phosphodienes, nucleoside triphosphate analogs, phosphoric amides, fluorophosphoric acids, etc. In another aspect, the biological material is a phosphorylated compound, i.e. a chemical compound to which a phosphate group has been added by the action of an enzyme such as a phosphorylase or a kinase. Phosphorylated compounds include, without limitation, proteins, polypeptides, phosphopeptides, nucleotides, polynucleotides, small molecule drugs that mimic nucleotides or polynucleotides, etc.

In an embodiment, the metal microparticulate layer on the superficially porous particle can be varied based on the affinity of a given metal for the target biological material. Methods for the selection of a particular metal for the specific binding of an analyte possessing a desired functional group are known to those of skill in the art, and generally follow the guidelines described by Pearson et al., J. Am. Chem. Soc., 85: 3533-3539 (1963). Under the HSAB theory, many metal ions can be classified as either hard or soft Lewis acids. The strongest bonds are formed between hard acids and hard bases, or soft acids and soft bases. For example, compounds containing oxygen (e.g. carboxylate), or phosphorus (e.g. phosphorylated proteins or nucleotides) are classified as hard bases and show greatest affinity for metal ions like Ca²⁺, Al³⁺, Ga³⁺, Mg²⁺, Ti⁴⁺, Zr⁴⁺ and Fe³⁺, which are classified as hard acids. Transition metal ions like Ni²⁺, Zn²⁺, etc. are known as borderline Lewis acids and have affinity for borderline and soft Lewis bases. Various metals may, in theory, be used as selection media. For example, with phosphorylated compounds, the negatively charged phosphate group acts as an electron donating Lewis base that can bind to coordination sites on a multivalent metal cation.

In an embodiment, the metal microparticulate layer on the superficially porous microparticle is chosen based on its affinity for the biological material being separated. In one aspect, the macroparticulate core is coated with a layer of Ni(II) metal for the selection of His-tagged proteins. In another embodiment, the macroparticulate core is coated with a layer of Pt(II) metal for the selection of sulfur-containing compounds. In yet another embodiment, the macroparticulate core is coated with a layer of Ti(IV) metal for the selection of phosphopeptides.

Methods for Coating of a Metal on a Superficially Porous Support

In one embodiment, the metal of interest is coated or clad by fusion, adsorption, or sintering onto the superficially porous support, or components thereof. In an aspect, the metal is directly incorporated onto the surface (surface herein defined as the microparticle surface) of the superficially porous particle. In an embodiment, the metal is coated or clad onto the superficially porous microparticle. Coating or cladding of the metal may be accomplished by, for example, electrochemical deposition of the metal. In another aspect, the metal may be coated or clad onto the superficially porous particle surface through vapor deposition. In yet another aspect, the metal can be coated or clad onto the superficially porous particle by impregnation of the support with a metal salt, followed by hydrolysis and calcination.

In a further embodiment, the metal of interest is coated or clad onto a fully silica-based superficially porous support. In an embodiment, a thin monolayer of metal is permanently deposited on the outer silica-based microparticle layer without altering the morphology or characteristics of the support. In one aspect, nearly linear or branched soluble oligomers (or sols) of metal alkoxides are combined with the superficially porous supports by dipping or spinning to form a metal-coated outer layer on the superficially porous support. The amorphous metal films formed in this way can be annealed at low temperature to produce dense and crystalline monolayers of metal on the silica surface. Metal oxide films formed on spherical silica particles using this method were described in Retuert et al., J. Mat. Chem 10: 2818-22 (2000). The sol-gel coating-process provides reproducible compositions and coatings with reproducible thickness.

Methods for Separation of Biological Material Using Superficially Porous Supports

The description herein provides methods for separation of a target biological material using a superficially porous support. By “target biological material” is meant the specific biological material to be separated from a mixture of components in a sample. The methods described herein comprise contacting the support (or stationary phase, when the support is used as a column in chromatography) with the sample mixture to capture the target biological material. In an embodiment, the metal coating on the support is chosen so as to be available for interactions with phosphorylated compounds such as, for example, Al(III), Fe(III), Ga(III), Ca(II) or Ti(IV) for proteins, polypeptides, polynucleotides, or other phosphorylated compounds; Ni(II) for His-tagged proteins; or Pt(II) for sulfur-containing compounds.

In embodiments, the pH at which the separation is performed can be varied. In one aspect, the pH range can be adjusted to optimize binding of the target material to the metal-coated superficially porous support, while minimizing binding of contaminants or non-target components of the sample mixture. The target material captured on the support can be further separated by standard elution procedures. In another aspect, the pH is varied such that the target material is not bound to the support, but instead is collected in the pass-through fraction. In such cases, elution is not required in order to separate the material from the support.

In embodiments, the methods described herein are used for the separation of phosphorylated materials. Variation of pH is used to optimize binding of phosphate to the metal-coated support, while minimizing carboxylic acid binding (from aspartic and glutamic acid residues), as a way of separating phosphorylated compounds from the sample mixture. Unlike IMAC, the non-ligand outer metal layer or coating is stable at all pH values. In another aspect, the pH can be adjusted to maximize carboxylic acid binding to the support, effectively removing any carboxylate contamination from the sample mixture, before the desired biological material is separated from the sample mixture. In an embodiment, the separation is carried out in the pH range of approximately 1-3, which is optimal for capturing phosphorylated compounds on the support.

In embodiments, the pH can be modified to the desired value using a buffer, appropriately pH-adjusted. Buffer systems are known and generally include one or more basic compounds and conjugate acids, such as sodium acetate, or with the addition of acids, such as acetic acid and trifluoroacetic acid. Other example buffer systems include, but are not limited to, maleate, glycine, citrate, formate, succinate, and acetate.

Biological material captured on the superficially porous support surface can be separated from the support using standard elution procedures and techniques known to those of skill in the art. In an aspect, the elution removes the biological material without affecting either the metal coating or the superficially porous metal particle. Elution of phosphorylated compounds from the solid support can be accomplished using buffers containing phosphate salts or ammonium hydroxide.

Phosphorus-containing compounds separated using a metal superficially porous support can be detected and/or quantified and/or further characterized to determine their properties (e.g., amino acid sequence, mass/charge ratio, etc). In one aspect, separated proteins or peptides can be analyzed by a proteomics analysis method, such as, for example, two-dimensional gel electrophoresis. In another aspect, separated proteins can be analyzed by mass spectrometry methods including, but not limited to, MALDI-TOF MS, ESI, TOF, ion trap MS, ion trap/TOF MS, quadrupole mass spectrometry, FT-MS, fast atomic bombardment (FAB), plasma desorption (PD), thermospray (TS), magnetic sector mass spectrometry, etc. The separated proteins or peptides may also be analyzed by NMR and other techniques. The separated proteins or peptides may be analyzed collectively, or individually, to identify proteins.

In embodiments, prior to separation on a metal-coated superficially porous support, the sample can be contacted with an immunoaffinity stationary phase to enrich the sample with one or more types of protein or protein fragments. In other aspects, proteins may also be contacted with a cleaving agent such as, for example, trypsin, to generate peptides. The cleaving step may also be carried out after separation on a metal-coated superficially porous support. In embodiments, where the target material is collected in the pass-through fraction, additional processing steps may be used to purify or separate the target material from other components that may be present in the pass-through fraction.

The various embodiments described above are provided by way of illustration only and should not be construed to limit the claims. Those skilled in the art will readily recognize various modifications and changes that may be made to the present methods without following the example embodiments and applications illustrated and described herein, and without departing from the true spirit and scope of the present claims.

1. A method for separating a biological material from a sample, comprising:
contacting a metal-coated superficially porous support with the sample; and
capturing the biological material on the support; or
collecting the biological material in the pass-through fraction.

2. The method of claim 1, wherein capturing the biological material on the support further comprises varying the pH to promote binding of the biological material to the support.

3. The method of claim 1, wherein the superficially porous support is part of a column, spin tube, coated membrane, or powder.

4. The method of claim 1, wherein the sample comprises one or more of lipids, amino acids, peptides, proteins, sugars, oligosaccharides, or mixtures thereof.

5. A method for separating one or more target biological materials from a sample mixture, comprising:
contacting a metal-coated superficially porous support with the sample mixture; and
capturing one or more target biological materials on the support; or
collecting one or more target biological materials in the pass-through fraction,
wherein one or more target materials are captured on the support or collected in the pass-through fraction, but other components of the sample mixture are not captured or collected.

6. The method of claim 5, wherein capturing one or more target biological materials on the support further comprises varying the pH to promote binding of the target biological materials to the support.

7. The method of claim 5, wherein the target biological material comprises one or more of a lipid, amino acid, peptide, protein, sugar, or oligosaccharide present in a sample mixture.

8. The method of claim 5, wherein the metal coating on the superficially porous support is Ni(II).

9. The method of claim 8, wherein the support is used to separate His-tagged proteins from a sample mixture.

10. The method of claim 5, wherein the metal coating on the superficially porous support is Pt(II).

11. The method of claim 10, wherein the support is used to separate sulfur-containing proteins from a sample mixture.

12. The method of claim 5, wherein the metal coating on the superficially porous support is Ti(IV).

13. The method of claim 12, wherein the support is used to separate phosphorus-containing proteins from a sample mixture.
